(19) United States
(12) Patent Application Publication
(10) Pub. No.: US 2010/0325893 A1
(43) Pub. Date: Dec. 30, 2010

(54) INNER EDGE OF RECIPROCATING ELECTRIC SHAVER

(75) Inventors: Shunsuke Komori, Hikone (JP); Hiroaki Shimizu, Hikone (JP); Takeshi Shiba, Hikone (JP); Jyuzaemon Iwasaki, Nagahama (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/667,781

(22) PCT Filed: Jul. 3, 2008
(86) PCT No.: PCT/JP2008/062093

§ 371 Date: Jan. 5, 2010

(30) Foreign Application Priority Data
Jul. 12, 2007 (JP) 2007-183624

(51) Int. Cl. B26B 19/02

(52) U.S. Cl. 30/43.92

(57) ABSTRACT

An inner edge of a reciprocating electric shaver includes an inner edge body, and an inner edge joint that supports the inner edge body, the inner edge body having a plurality of edge pieces which have an inverse U shape, slide along an inner surface of an outer edge, and cut beard. Then, in the inner edge joint, there are provided: a plurality of vibration plates which is connected to any of the plurality of edge pieces, and generates a shaving sound at a time of cutting the beard; and a support portion that supports the respective vibration plates, and the support portion is adapted to support a single point of each of the vibration plates.

### TECHNICAL FIELD

The present invention relates to an inner edge of a reciprocating electric shaver, and specifically, relates to a structure in which a plurality of vibration plates is provided on an inner edge joint.

### BACKGROUND ART

Heretofore, for example as shown in FIG. 1, as an inner edge of a reciprocating electric shaver, an edge is known, in which vibration plates 40 are attached to support portions 41 provided on an inner edge joint 4, top portions of the vibration plates 40 are connected to any edge pieces 30 of an inner edge body 3, and the vibration plates 40 vibrate at the time of shaving, whereby a comfortable vibration sound (shaving sound) is adapted to be generated.

However, in the above-described conventional example, both sides P3 and P4 of a lower end of each of the vibration plates 40 are supported by two points on the two front and rear support portions 41, and accordingly, vibrations of the vibration plates 40 are restricted by the support portions 41, whereby there are limitations on largely vibrating the vibration plates 40. Therefore, the conventional inner edge of the reciprocating electric shaver has not been able to respond to a request that the comfortable shaving sound should be increased.

[Patent Literature 1] Japanese Patent Laid-Open Publication No. H7-222880

### DISCLOSURE OF INVENTION

### Technical Problem

The present invention has been invented in consideration of such a conventional problem described above. It is an object of the present invention to provide an inner edge of a reciprocating electric shaver, in which a degree of freedom of the vibration plates supported by the support portion of the inner edge joint is enhanced, the comfortable shaving sound can be thereby increased as much as possible, and beard waste is less likely to be accumulated below the vibration plates.

### Technical Solution

In order to achieve the above-described object, an inner edge of a reciprocating electric shaver, which includes an inner edge body 3, and an inner edge joint 4 that supports the inner edge body 3, the inner edge body 3 having a plurality of edge pieces 30 which have an inverse U shape, slide along an inner surface of an outer edge 1, and cut beard, is characterized in that, in the inner edge joint 4, there are provided: a plurality of vibration plates 40 which is connected to any of the plurality of edge pieces 30, and generates a shaving sound at a time of cutting the beard; and a support portion 41 that supports the respective vibration plates 40, and the support portion 41 is formed into a single point support structure of supporting a single point of each of the vibration plates 40.

With such a configuration adopted, in the event where the plurality of edge pieces 30 cuts the beard at the time of shaving, the vibration plates 40 coupled to the edge pieces 30 vibrate, and a comfortable shaving sound is generated. In addition, each of the vibration plates 40 is supported by the single point by means of the support portion 41. Accordingly, the degree of freedom of the respective vibration plates 40 with respect to the support portion 41 is enhanced, and a vibration amount of each of the vibration plates 40 can be increased in comparison with the conventional “double point” support structure. As a result, the shaving sound that is comfortable for a user can be increased as much as possible. Moreover, the support portion 41 that supports each of the vibration plates 40 by the single point can be formed thin, and the beard waste becomes less likely to be accumulated below the vibration plates 40.

Moreover, it is preferable that the support portion 41 be formed into a center single point support structure of supporting a center P1 of a lower end of each of the vibration plates 40 by the single point. In such a way, the support for the vibration plates 40 can be stabilized.

Moreover, it is preferable that the support portion 41 be formed into a one-sided single point support structure of supporting either side P2 of both front and rear sides of a lower end of each of the vibration plates 40 by the single point. In such a way, the support portion 41 is arranged aside, whereby the beard waste can become much less likely to be accumulated below the vibration plates 40. Moreover, with regard to each of the vibration plates 40, which is supported by the single point on one side, a moment of vibrations thereof is increased, and each of the vibration plates 40 becomes capable of obtaining larger variations.

Moreover, it is preferable that spaces 70 be formed below the support portion 41. In such a way, the beard waste drops down into the spaces 70, whereby the beard waste becomes less likely to be accumulated in the peripheries of the vibration plates 40 and the support portion 41 that supports the vibration plates 40.

### ADVANTAGEOUS EFFECT OF THE INVENTION

In accordance with the present invention, the single point support structure is adopted, in which each of the plurality of vibration plates is supported by the single point by means of the support portion of the inner edge joint. Accordingly, the degree of freedom of each of the vibration plates is enhanced, and it becomes possible to increase the vibration amount of each of the vibration plates. As a result, the inner edge of the reciprocating electric shaver is obtained, in which the shaving sound that is comfortable for the user can be increased as much as possible, and the beard waste becomes less likely to be accumulated below the vibration plates.

### BRIEF DESCRIPTION OF THE DRAWINGS

FIG. 1 is an explanatory view of a conventional example.

FIG. 2 is an exploded perspective view explaining a case, in a case where the number of blade heads of a reciprocating electric shaver is four, where vibration plates are attached to an inner edge joint of either one blade head arranged between two main blade heads among them.

FIG. 3 shows a first embodiment of the present invention:

FIG. 3(a) is an exploded perspective view of the main blade head composed of an inner edge block including an inner edge body and the inner edge joint, an outer edge block, and a guide frame that guides these blocks; and FIG. 3(b) is a perspective view of a holding frame that holds the guide frame.

FIG. 4 is an exploded perspective view of the inner edge body according to the first embodiment of the present invention, and the inner edge joint including the vibration plates and the support portion that supports the vibration plates.

FIG. 5 is a perspective view of the inner edge joint according to the first embodiment of the present invention.

FIG. 6 is a plan view of the inner edge joint according to the first embodiment of the present invention.

FIG. 7 is a side view of the inner edge joint according to the first embodiment of the present invention.

FIG. 8 is a longitudinal cross-sectional view of the inner edge joint according to the first embodiment of the present invention.

FIG. 9 is a longitudinal cross-sectional view of an inner edge joint in a case where a support portion according to a second embodiment of the present invention is arranged aside.

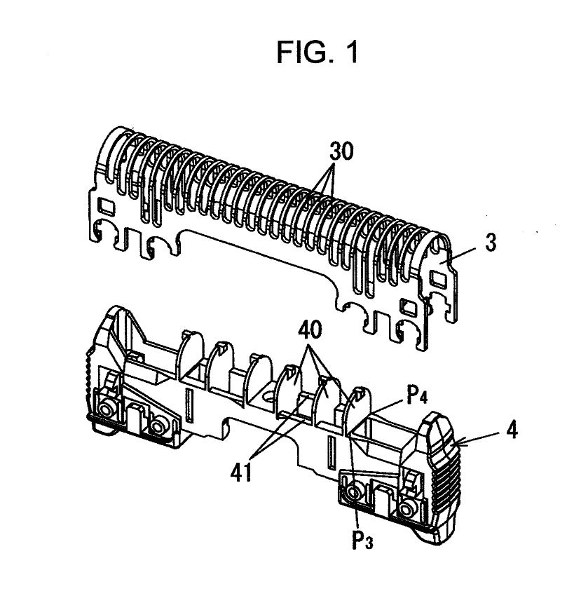

### BEST MODE FOR CARRYING OUT THE INVENTION

A description will be made below of embodiments of the present invention with reference to the drawings.

### First Embodiment

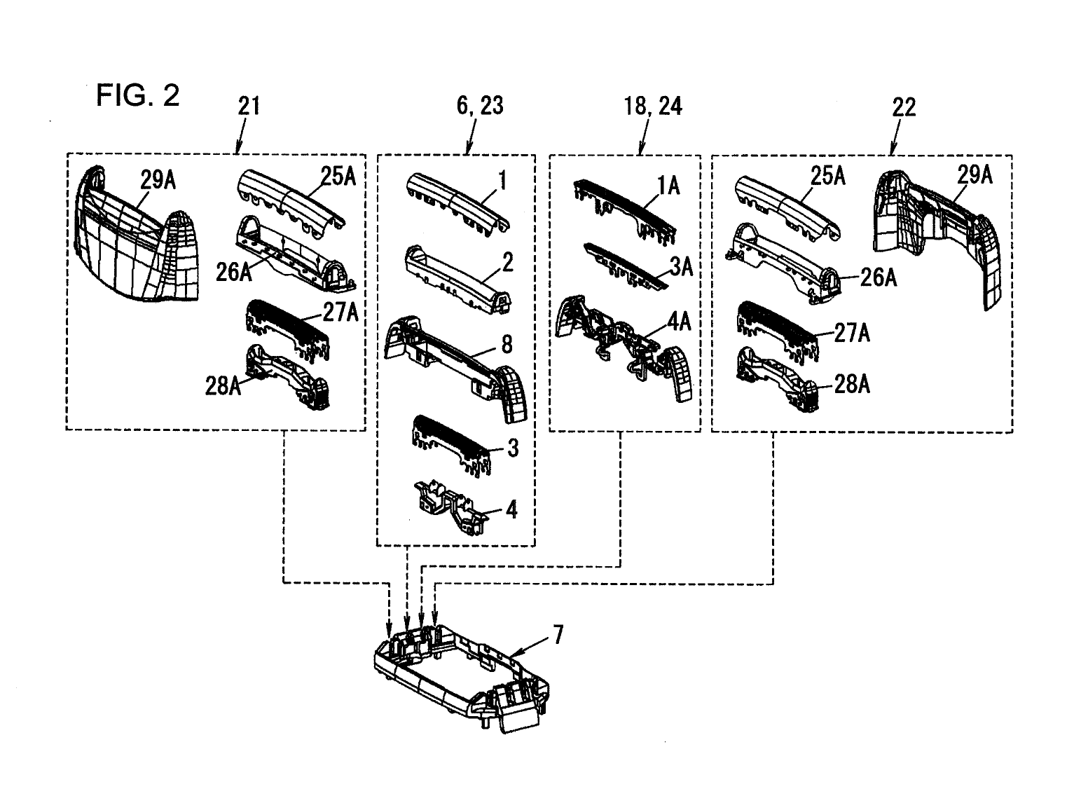

Onto a head portion of a reciprocating electric shaver according to this embodiment, for example as shown in FIG. 2, four blade heads 21 to 24 freely floatable independently of one another are attached freely detachably. Among them, two auxiliary blade heads 23 and 24 are arranged side by side in the center of the head portion, and two arch-like main blade heads 21 and 22 for finish shaving are individually arranged on both outsides of the head portion.

In FIG. 2, as heretofore, each of the two finish shaving main blade heads 21 and 22 is composed of an outer edge 25A, an outer edge frame 26A, an inner edge 27A, an inner edge joint 28A, an outer edge cover 29A, and the like.

Moreover, one of the two auxiliary blade heads 23 and 24 is composed of an arch-like finish shaving blade block 6, and the other is composed of a blade block 18 for rough shaving, which includes a slit edge 1A, an inner edge 3A, an inner edge joint 4A, and the like.

A description will be made below of the finish shaving blade block 6 that composes the auxiliary blade head 23. Note that, in the following, a direction where an inner edge reciprocates is defined as a longitudinal direction A or a right-and-left direction, and a direction perpendicular to this direction is defined as a front-and-rear direction B.

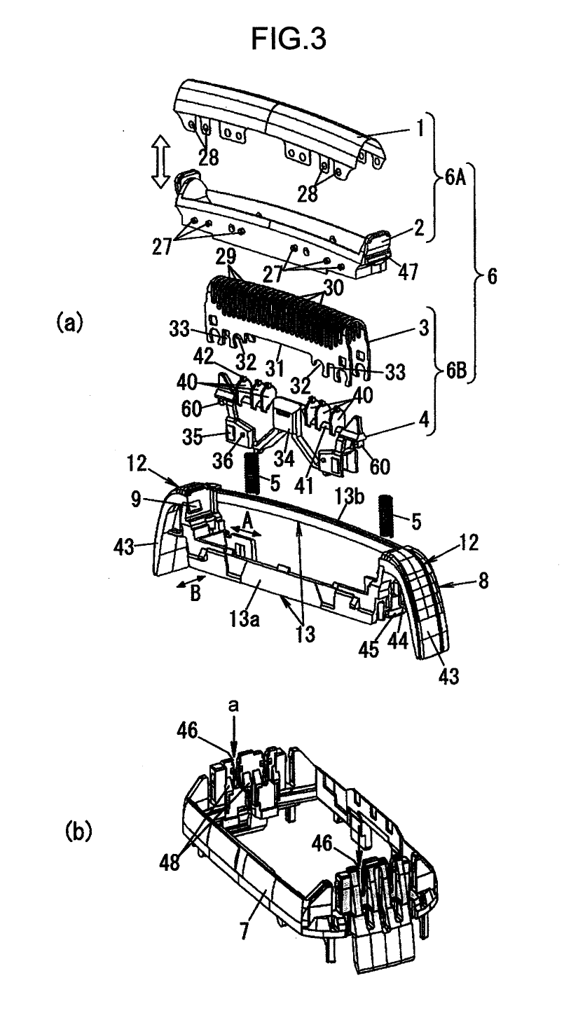

As shown in FIG. 3, the finish shaving blade block 6 is composed of: an outer edge block 6A formed of an outer edge 1 (net edge) made of a thin metal sheet having a large number of edge holes, and an outer edge frame 2 that fixes the outer edge 1 thereto; and an inner edge block 6B formed of an inner edge body 3 arranged under a lower surface of the outer edge 1, an inner edge joint 4 that couples the inner edge body 3 to a drive side, and inner edge push-up springs 5 which press the inner edge body 3 toward an inner surface of the outer edge 1.

On both front and rear lower surfaces of the above-described outer edge frame 2, heat seal bosses 27 are individually protruded. Moreover, the outer edge 1 and the outer edge frame 2 are fixed to each other in a heat-sealed manner in a state where engagement holes 28 individually provided on both front and rear lower surfaces of the outer edge 1 are fitted to the heat seal bosses 27 by bowing the outer edge 1 into an arch shape.

The inner edge body 3 is formed in such manner that sheet metal is subjected to press bending and the entirety thereof is formed into an arch shape. Moreover, in an upper portion of the inner edge 3, which forms a substantially circular-arc protruding shape in cross section, plural edge pieces 30 which have an inverse U shape and are formed by forming plural slit holes 29 therein are arrayed. In lower portions extended individually downward from both front and rear lower ends of the inner edge body 3, notched portions 31 are individually recessed on centers thereof, circular recessed portions 32 which have a substantially circular shape and are open downward are individually recessed on both right and left sides of the notched portions 31, and further, square recessed portions 33 which have a substantially rectangular shape and are open downward are individually recessed on outsides of the circular recessed portions 32.

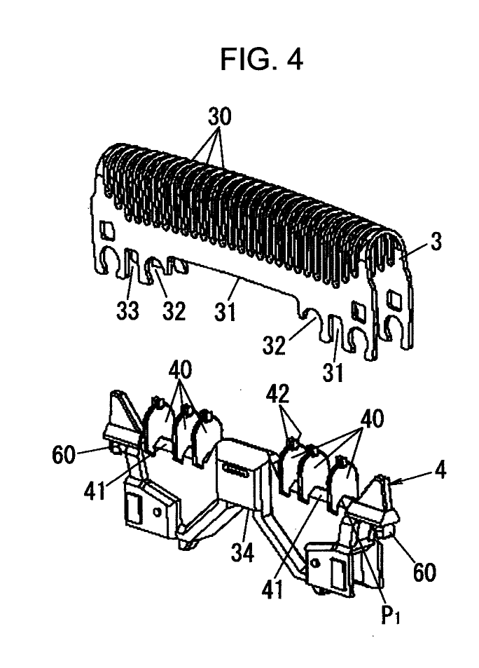

In a center of a lower portion of the inner edge joint 4, a coupling recessed portion 34 freely detachably coupled to a driver side of a shaver body is provided. On both surfaces of the inner edge joint 4, which face to the front-and-rear direction B, prism-like square protruding portions 35 and cylindrical heat seal bosses 36 are protruded side by side. Then, the heat seal bosses 36 are heat-sealed in a state where the inner edge joint 4 is inserted from below the inner edge 3 into an inside thereof and the heat seal bosses 36 of the inner edge joint 4 are fitted into and positioned to the circular recessed portions 32 of the inner edge body 3, whereby the inner edge joint 4 is attached to the inner edge body 3. In addition, in the state where the inner edge joint 4 is attached to the inner edge body 3, the square protruding portions 35 of the inner edge joint 4 are fitted to the square recessed portions 33 of the inner edge body 3, whereby right-and-left positioning of the inner edge body 3 with respect to the inner edge joint 4 is performed. Note that reference numerals 60 in FIG. 4 denote spring receiving portions.

Moreover, the above-described finish shaving blade block 6 is adapted to be held, so as to be freely floatable, on a holding frame 7, which is provided on the shaver body, while interposing a guide frame 8 shown in FIG. 3 therebetween.

In the guide frame 8, a pair of frame portions 12 located on both ends thereof in the longitudinal direction A and a coupling portion 13 that couples the pair of frame portions 12 to each other are formed integrally with one another. Moreover, coupling portions 9 are individually provided on inner surfaces of the pair of frame portions 12, guide protrusions 45 held on the holding frame 7 so as to be freely floatable are individually provided on outer surfaces of the respective frame portions 12, and spring receiving portions 10 are individually provided on a bottom surface portion of the guide frame 8, which is extended in the longitudinal direction A from lower ends of the respective frame portions 12.

Moreover, cover pieces 43 are individually provided on outer side surfaces of the respective frame portions 12. Longitudinal ribs 44 are formed on inner surfaces of the respective cover pieces 43, and guide protrusions 45 are protruded on outer surfaces of the frame portions 12, which are opposite to the cover pieces 43. Meanwhile, on the holding frame 7, there are provided: recessed grooves 46 which are open upward and into which the above-described longitudinal ribs 44 are inserted from above (in a direction of an arrow of FIG. 3B); and engagement protrusions 48 with which the guide protrusions 45 engage. Then, the guide protrusions 45 are engaged with the engagement protrusions 48 in a state where the longitudinal ribs 44 of the respective frame portions 12 are made freely floatable along the recessed grooves 46 of the outer edge frame 2, whereby the guide frame 8 is assembled with the holding frame 7 in a state of not being detached therefrom with ease.

The coupling portion 13 of the above-described guide frame 8 is composed of one or more walls 13a and 13b individually arranged on both sides of the guide frame 8 in the front-and-rear direction B perpendicular to the longitudinal direction A thereof. One end of each of the walls 13a and 13b in the longitudinal direction A is made to continue with a bottom surface portion of one of the frame portions 12, and the other end of each of the walls 13a and 13b in the longitudinal direction A is made to continue with a bottom surface portion of the other frame portion 12. In FIG. 3, the coupling portion 13 is composed of totally two walls, which are the one wall 13a on the front side, and the one wall 13b on the rear side, and the outer edge frame 2 that fixes the outer edge 1 thereto is adapted to be arranged between the two walls 13a and 13b. Note that the number of walls 13a and 13b is not particularly limited, and is freely changeable as appropriate.

Moreover, as shown in FIG. 3, the coupling portions 9 of the above-described guide frame 8 are foamed into hooks which protrude inward from both ends of the guide frame 8 in the longitudinal direction A. Then, hooks 47 provided on both ends of the outer edge frame 2 in the longitudinal direction A are hung on the hook-like coupling portions 9, whereby the outer edge frame 2 and the guide frame 8 are adapted to be coupled to each other.

In the event of assembling the finish shaving blade block (outer edge block 6A and inner edge block 6B) having the above-described configuration, the outer edge block 6A is assembled in advance by fixing the outer edge 1 and the outer edge frame 2 to each other in the heat-sealing manner. Hence, spring urging force from the inner edge push-up springs 5 is not applied to the outer edge 1 at the time of assembling the outer edge 1 and the holding frame 7 with each other. Accordingly, even in a case where rigidity of the outer edge 1 is not only high but also low, it becomes possible to couple the outer edge 1 to the outer edge frame 2 without deforming the outer edge 1, and the assembly of the outer edge block 6A can be performed with ease. Thereafter, in a state where lower ends of the inner edge push-up springs 5 are supported by the spring receiving portions 10 of the guide frame 8, and where upper ends of the inner push-up springs 5 are fitted into the spring receiving portions 60 of the inner edge joint 4 fixedly attached integrally with the inner edge body 3, the hooks 47 provided on both ends of the outer edge frame 2 in the longitudinal direction A are coupled to the hook-like coupling portions 9 provided on both ends of the guide frame 8 in the longitudinal direction A so as to cover the inner edge 3 with the outer edge 1 of the above-described outer edge block 6A. In such a way, the finish shaving blade block 6 is completed.

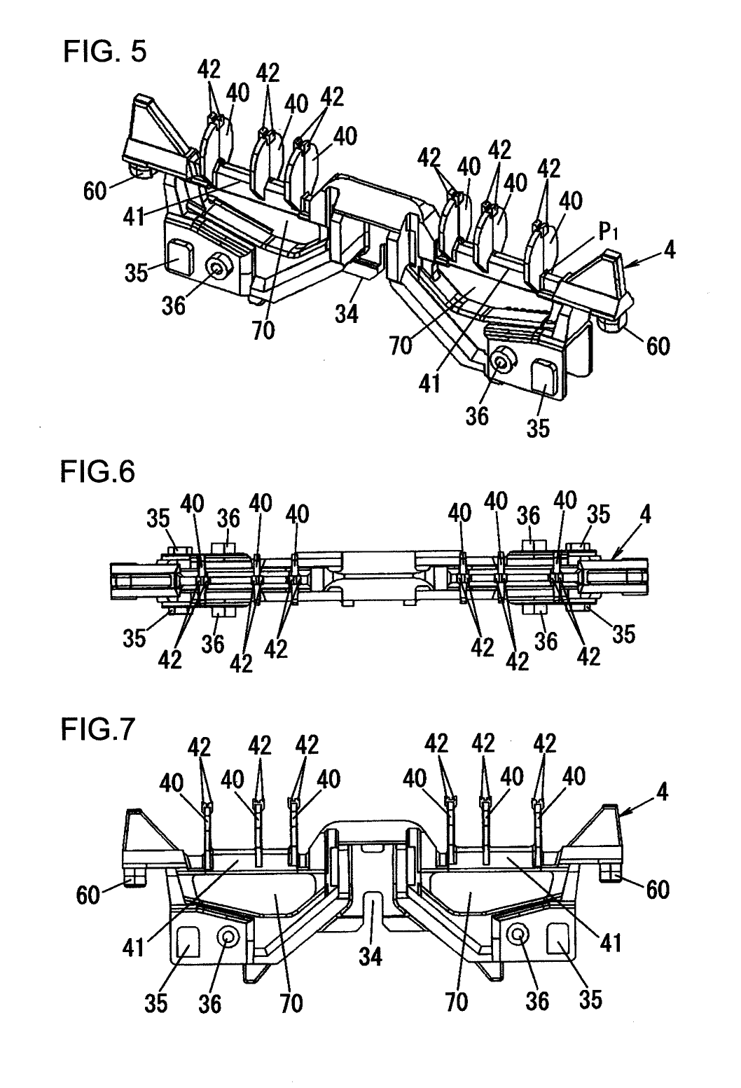

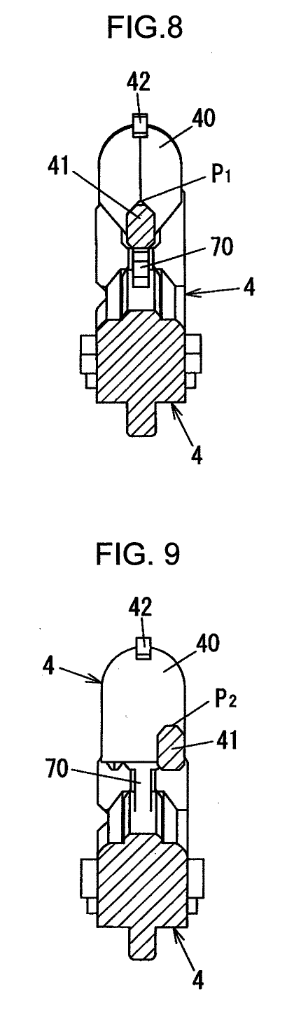

Here, in the present invention, as shown in FIG. 4, plural vibration plates 40 and one support portion 41 that supports these vibration plates 40 are provided on an upper portion of the above-described inner edge joint 4. The plural vibration plates 40 are vertically arranged below several (for example, four to six) edge pieces 30 among the plural edge pieces 30 provided on the inner edge body 3. The respective vibration plates 40 are individually formed into an inverse U shape bent along inner surfaces of the edge pieces 30 having the inverse U shape. Moreover, as shown in FIG. 5 to FIG. 8, a right and left pair of protruding pieces 42 is provided on an upper end of a top portion of each of the vibration plates 40. Then, a lower surface of a top portion of one edge piece 30 is sandwiched from right and left by the right and left pair of protruding pieces 42, whereby the upper end of one vibration plate 40 and the lower surface of the top portion of one edge piece 30 opposite to the vibration plate 40 concerned are coupled and fixed to each other in the right-and-left direction (that is, the reciprocating direction of the inner edge body 3). Furthermore, each lower end portion of the respective vibration plates 40 is molded integrally with the one support portion 41 of the inner edge joint 4. Here, a “center single point” support structure in which a lower end center P1 of each of the vibration plates 40 is supported by the single point is adopted, whereby a degree of freedom of each of the vibration plates 40 is enhanced. In such a way, a mechanism is made, in which, in the event where the edge pieces 30 of the inner edge body 3 cut the beard at the time of shaving, the vibration plates 40 coupled to the edge pieces 30 vibrate to generate a comfortable sound (shaving sound).

In accordance with this embodiment described above, each of the vibration plates 40, which is coupled to the edge piece 30 and vibrates, and thereby generates the comfortable shaving sound when the edge pieces 30 of the inner edge body 3 cut the beard at the time of shaving, is supported by the single point by means of the one support portion 41. Accordingly, the degree of freedom of the respective vibration plates 40 with respect to the support portion 41 can be enhanced, and a vibration amount of each of the vibration plates 40 can be increased in comparison with the conventional “double point” support structure. As a result, the shaving sound that is comfortable for a user can be increased as much as possible. Moreover, the lower end center P1 of each of the vibration plates 40 is supported by the single point, and accordingly, there is an advantage that the support for the vibration plates 40 by means of the support portion 41 is stabilized more.

In addition, the one support portion 41 that supports the lower end of each of the vibration plates 40 by the single point can be formed thin, and accordingly, beard waste becomes less likely to be accumulated on the support portion 41. Furthermore, as shown in FIG. 5 and FIG. 7, spaces 70 are formed under the support portion 41 for the vibration plates 40, whereby the beard waste can be allowed to escape into the spaces 70. Accordingly, as a result, there is another advantage that the beard waste can be surely prevented from being accumulated under the vibration plates 40.

### Second Embodiment

In the above-described first embodiment, the description has been made of the “center single point” support structure for each of the vibration plates 40. In this embodiment, as shown in FIG. 9, a “one-sided single point” structure is adopted, in which the support portion 41 for the vibration plates 40 is arranged to be close to either side of both front and rear sides of each of the vibration plates 40, and one side P2 of the lower end of each of the vibration plates 40 is supported by the single point. Note that other configurations are similar to those of the above-described first embodiment. Also when the support portion 41 is arranged to be close to one side as described above, an effect that the beard waste becomes less likely to be accumulated can be obtained as in the above-described first embodiment by the fact that opening portions below the vibration plates 40 are widened. Moreover, each of the vibration plates 40 is supported by a one-sided single point, whereby a distance from a one-sided single point P2 to the protruding pieces 42 is elongated. Accordingly, a moment of the vibrations of each of the vibration plates 40 is increased, and there is also an effect that larger vibrations can be obtained.

Note that, in each of the embodiments described above, as the blade heads of the reciprocating electric shaver, the four blades shown in FIG. 2 have been illustrated, in which the two auxiliary blade heads 23 and 24 are arranged between the two main blade heads 21 and 22; however, the blade heads are not limited to this configuration, and for example, the blade heads may be three blades in which the one auxiliary blade head 23 or 24 is arranged between the two main blade heads 21 and 22. In both of the cases, the large and comfortable shaving sound can be generated by using the auxiliary blade head 23 (or 24) including the inner edge joint 4 that supports the vibration plates 40.

### INDUSTRIAL APPLICABILITY

In accordance with the present invention, the inner edge of the reciprocating electric shaver can be obtained, in which the degree of freedom of the vibration plates supported by the support portion of the inner edge joint is enhanced, whereby the comfortable shaving sound can be increased as much as possible, and in addition, the beard waste becomes less likely to be accumulated below the vibration plates.

1. An inner edge of a reciprocating electric shaver, which includes an inner edge body, and an inner edge joint that supports the inner edge body, the inner edge body having a plurality of edge pieces which have an inverse U shape, slide along an inner surface of an outer edge, and cut beard, wherein, in the inner edge joint, there are provided: a plurality of vibration plates which is connected to any of the plurality of edge pieces, and generates a shaving sound at a time of cutting the beard; and a support portion that supports the respective vibration plates, and the support portion is formed into a single point support structure of supporting a single point of each of the vibration plates.

2. The inner edge of a reciprocating electric shaver according to claim 1, wherein the support portion is formed into a center single point support structure of supporting a center of a lower end of each of the vibration plates by the single point.

3. The inner edge of a reciprocating electric shaver according to claim 1, wherein the support portion is formed into a one-sided single point support structure of supporting either side of both front and rear sides of a lower end of each of the vibration plates by the single point.

4. The inner edge of a reciprocating electric shaver according to any one of claim 1, wherein a space is formed below the support portion.

5. The inner edge of a reciprocating electric shaver according to claim 2, wherein a space is formed below the support portion.

6. The inner edge of a reciprocating electric shaver according to claim 3, wherein a space is formed below the support portion.
